(19) United States
(12) Patent Application Publication
(10) Pub. No.: US 2016/0148115 A1
(43) Pub. Date: May 26, 2016

(54) EASY DEPLOYMENT OF MACHINE LEARNING MODELS

(71) Applicant: Microsoft Technology Licensing, Redmond, WA (US)

(72) Inventors: Joseph Sirosh, Bellevue, WA (US); Mohan Krishna Bulusu, Bellevue, WA (US); Vijay Narayanan, Mountain View, CA (US); Ritwik Bhattacharya, Redmond, WA (US); Srikanth Shoroff, Bellevue, WA (US); Pedro Ardila, Seattle, WA (US); Alan Billing, Wayland, MA (US)

(21) Appl. No.: 14/554,413

(22) Filed: Nov. 26, 2014

(51) Int. Cl. G06N 99/00

(52) U.S. Cl. CPC G06N 99/005

(57) ABSTRACT

A machine learning model deployment tool can receive a trained machine learning model and driven by a series of user interfaces and by received user input from the user interfaces, can automatically generate machine learning model software and deploy it to a hosting environment. The deployment of a machine learning model can be automated so that custom code does not have to be written by a human. Deployment can be to a single computing device, to a small scale service, to a small scale web service or to “the cloud”, e.g., as a high-scale, fault-tolerant web service utilizing hundreds of computers. Deployment can be guided by a series of user interfaces.

### BACKGROUND

Instead of just following explicitly programmed instructions, some computing systems can learn by processing data. The process whereby a computing system learns is called machine learning. Machine learning can be advantageously employed wherever designing and programming explicit, rule-based algorithms for data computation is insufficient. Machine learning often is based on a statistical mathematical model. A mathematical model describes a system using mathematical concepts and language. A mathematical model is often used to make predictions about future behavior based on historical data.

Development of a mathematical model is typically the purview of a data scientist. The data scientist is expected to possess business acumen and the ability to spot trends by examining data. A data scientist is expected to look at data from many angles, determine what it means, and recommend ways to apply the data. One challenge today's data scientist faces involves getting a machine learning model deployed (operationalized). The concept of deployment encompasses the activities that make software or a software system available for use. Deployment frequently has to be customized to comply with particular requirements or characteristics of the software being deployed. Deployment is expensive, time-consuming and complex, typically requiring expertise outside the data science domain. The task of deploying a machine learning model usually requires a programmer and an information technology (IT) professional. The programmer typically writes custom code to convert the mathematical model into software and to deploy and update the model. The IT professional may choose a hosting environment and deploy the model to the hosting environment. When the system is operational, the IT professional and programmer may ensure its smooth and efficient operation.

### SUMMARY

The deployment of a machine learning model can be automated so that custom code does not have to be written by a human. Deployment can be to a single computing device, to a small scale service, to a small scale web service or to “the cloud”, e.g., as a high-scale, fault-tolerant web service utilizing hundreds of computers. Deployment can be guided by a series of user interfaces. The time it takes to perform this process can be just minutes. Updating of the machine learning model can be automated to consume user-supplied updated machine learning models. A scoring experiment can be created. Creation of a scoring experiment can encapsulate data, optional data transformations and a trained machine learning model into a software unit. The deployment process can be guided by user interfaces that prompt the user for information including but not limited to inputs and outputs for the application or service.

Custom code can be automatically generated in various languages including but not limited to C#, Python and R to invoke the service. Custom code can be automatically generated to test the trained model for a single outcome or for a batch of outcomes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a illustrates an example of a system 100 for deploying a machine learning model in accordance with aspects of the subject matter described herein;

FIG. 1b illustrates a more detailed example 101 of a portion of system 100 in accordance with aspects of the subject matter described herein;

FIG. 2a illustrates an example of a method 200 for deploying a machine learning model in accordance with aspects of the subject matter disclosed herein;

FIG. 2b illustrates an example of a user interface 230 for creating a scoring experiment in accordance with aspects of the subject matter disclosed herein;

FIG. 2c illustrates an example of a user interface 231 for running an example of a particular scoring experiment in accordance with aspects of the subject matter disclosed herein;

FIG. 2d illustrates an example of a user interface 260 for testing the web service in accordance with aspects of the subject matter disclosed herein;

FIG. 2e illustrates an example 270 of a custom code auto-generated in Python for invoking the machine learning model software in accordance with aspects of the subject matter disclosed herein;

FIG. 2f illustrates an example of a user interface 290 for providing a single outcome in accordance with aspects of the subject matter disclosed herein;

FIG. 2g illustrates an example of results 280 of an experiment in accordance with aspects of the subject matter disclosed herein;

FIG. 3 is a block diagram of an example of a computing environment in accordance with aspects of the subject matter disclosed herein.

### DETAILED DESCRIPTION

### Overview

Machine learning applies historical data to a topic by creating a model and using the model to predict future behavior or trends. Experiments that apply the model to data and generate results can be run. An experiment typically has a well-defined set of possible outcomes. An experiment is random if there are multiple possible outcomes. An experiment is deterministic if, given the same input, it always returns the same answer. A random experiment that has exactly two (mutually exclusive) possible outcomes is known as a Bernoulli trial. When an experiment is conducted many times and results are pooled, empirical probabilities of the various outcomes and events that can occur in the experiment can be calculated and statistical analysis can be performed. Creating a model (e.g., writing the formulas that predict outcomes based on historical data) typically requires the training and expertise of a data scientist. Translating the model and experiments into software typically requires a programmer Selecting a hosting environment and moving the software to the selected hosting environment typically requires an IT (information technology) professional. The process often takes months of work and careful communication between the individuals involved.

In accordance with aspects of the subject matter described herein, a tool to convert a machine learning model into an application or web service is described. The process can be quick and easy. The need for a programmer who creates custom code can be eliminated. The process can be automated (performed automatically by software) driven by input received from a series of user interfaces. The time it takes to convert a machine learning model into an application or service can be reduced from weeks or months to minutes. The machine learning model can be a machine learning model developed by a user such as a data scientist particularly for the particular problem space instead of a generic machine learning model applies to classes of problems. The machine learning model can be a trained machine learning model. A scoring experiment can be created, the experiment can be run, the software model can be tested, code that enables a user to access the model can be automatically generated and the model can be placed in a test, staging (pre-production) or production (non-test) environment. A user, (e.g., a data scientist) can use visual composition to create a scoring experiment by inserting a trained model and a generic model scoring module into the experiment. The user can insert test data and data transformation modules into the experiment. The user can select appropriate inputs and outputs to identify where the input data for the application or service flows in and where the output flows out. The user can specify what the input for the application or service is and what the output from the application or service is.

The experiment can be run. Outcomes can be displayed. In response to selection of an option, code can be automatically generated. Code that is automatically generated can be in various appropriate languages including but not limited to R, C Sharp and Python. The code that is automatically generated can include code that converts the model into software. The code that is automatically generated can include code that enables another application to consume the encoded model and/or code that enables a user to invoke the encoded machine learning model. A request for a single outcome or for a batch of outcomes can be requested.

### Easy Deployment of Machine Learning Models

An application or service can be automatically produced from a machine learning model by a tool. The tool can automatically place the application or service in a hosting environment. The process can be driven by a series of user interfaces that guide a user through the process of generating a web service by creating an experiment, testing it and placing the machine learning model software in a hosting environment. Placing the software in a hosting environment can involve placing it in a system running on the organization's premises, as a web service, as a large-scale system miming in the cloud or on a single computing device.

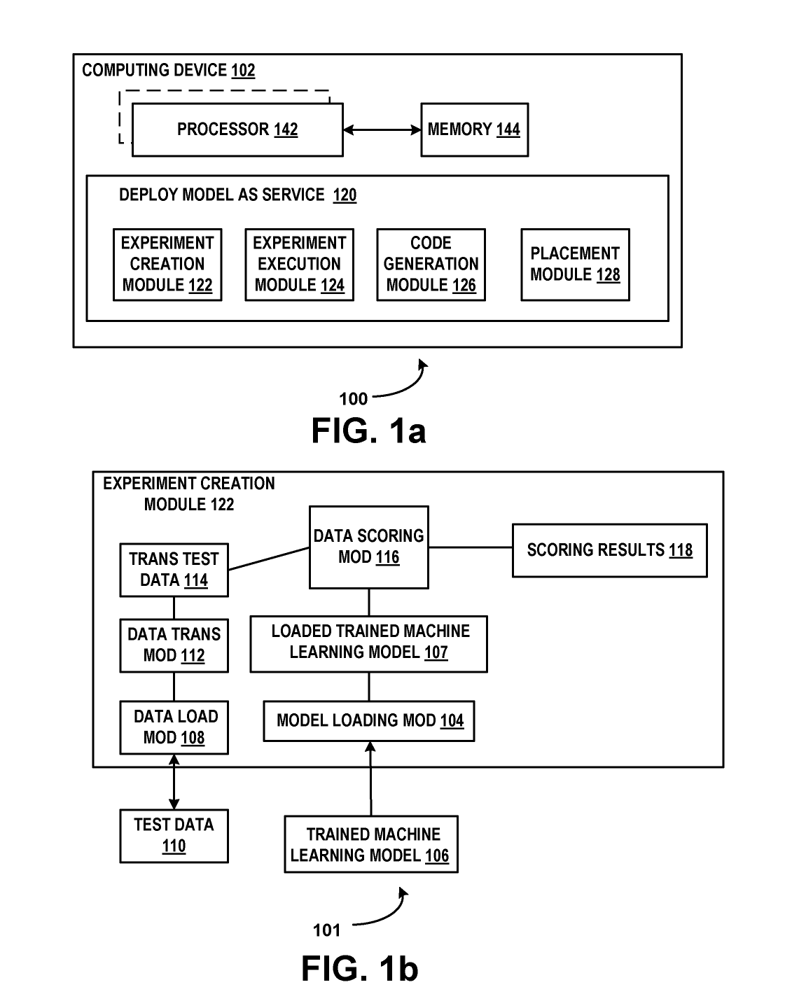

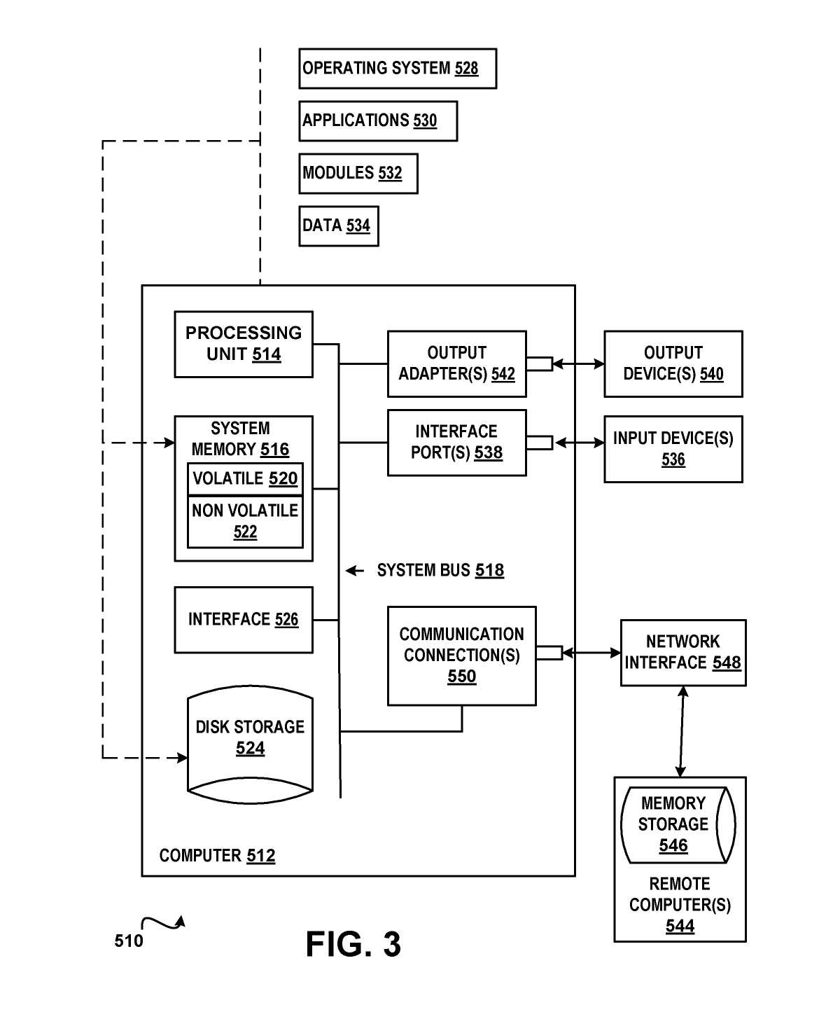

FIG. 1a illustrates an example of a system 100 that can deploy a machine learning model to an application or service. All or portions of system 100 may reside on one or more computers or computing devices such as the computers described below with respect to FIG. 3. System 100 or portions thereof may be provided as a stand-alone system or as a plug-in or add-in.

System 100 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

System 100 can include one or more computing devices such as, for example, computing device 102. Contemplated computing devices include but are not limited to desktop computers, tablet computers, laptop computers, notebook computers, personal digital assistants, smart phones, cellular telephones, mobile telephones, servers, virtual machines, devices including databases, firewalls and so on. A computing device such as computing device 102 can include one or more processors such as processor 142, etc., and a memory such as memory 144 that communicates with the one or more processors.

System 100 may include any one of or any combination of program modules comprising a system that deploys a machine learning model as a service (e.g., deploy model as service 120): one or more experiment creation modules such as experiment creation module 122, one or more test experiment modules such as experiment execution module 124, one or more code generation modules such as code generation module 126 and/or one or more placement modules such as placement module 128.

FIG. 1b illustrates a more detailed example of the one or more experiment creation modules of system 100. In FIG. 1b experiment creation modules 101 may include any one of or any combination of program modules comprising: a machine learning model loading module or modules, a machine learning model scoring module or modules, a data transformation module or modules, and/or a test data loading module or modules. System 100 may include any one of or any combination of: a machine learning model, test data and/or a test data schema.

The one or more machine learning model loading modules such as machine learning model loading module 104 can load a trained model such as trained machine learning model 106 into an experiment environment. The trained machine learning model 106 can be a model that has been trained in any suitable fashion, as is well known in the art. The trained machine learning model 106 can be a user-provided model that is generated by a user such as but not limited to a data scientist. The one or more data loading modules such as data loading module 108 can load data such as but not limited to test data 110. The one or more data transformation modules such as data transformation module 112 can receive test data 110 and perform data computations and/or data transformations on the test data 110 to created transformed test data 114 that can be provided to the loaded trained machine learning model 107. One or more data scoring modules such as data scoring module 116 can receive the transformed test data 114, and can apply the loaded trained machine learning model 107 to the transformed test data 114. Scoring results such as scoring results 118 can be provided (e.g., as a display or in any other suitable fashion).

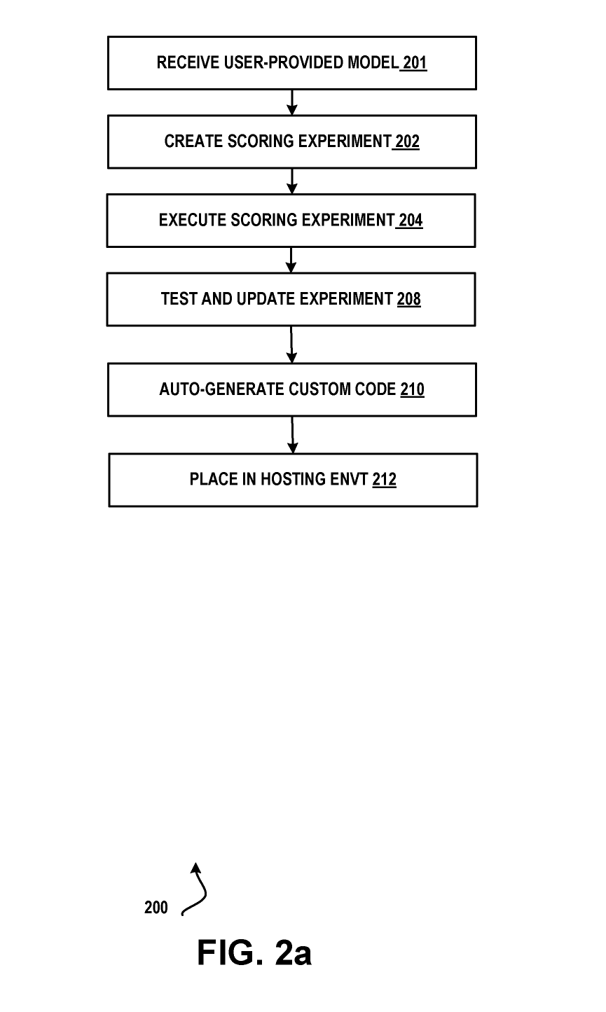

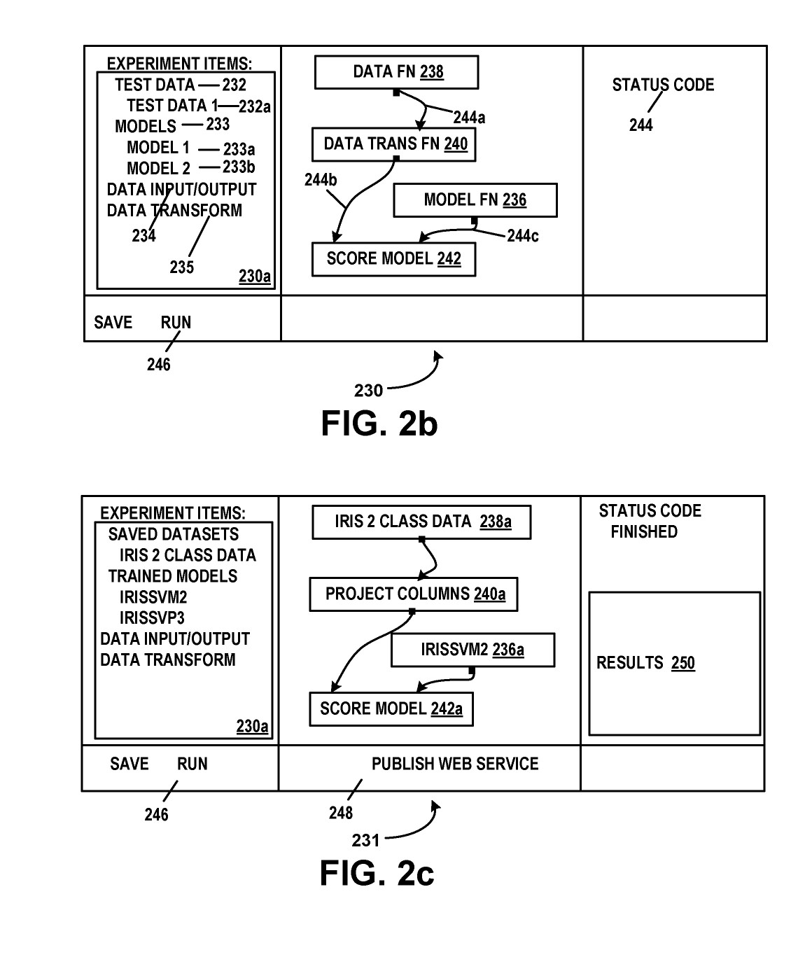

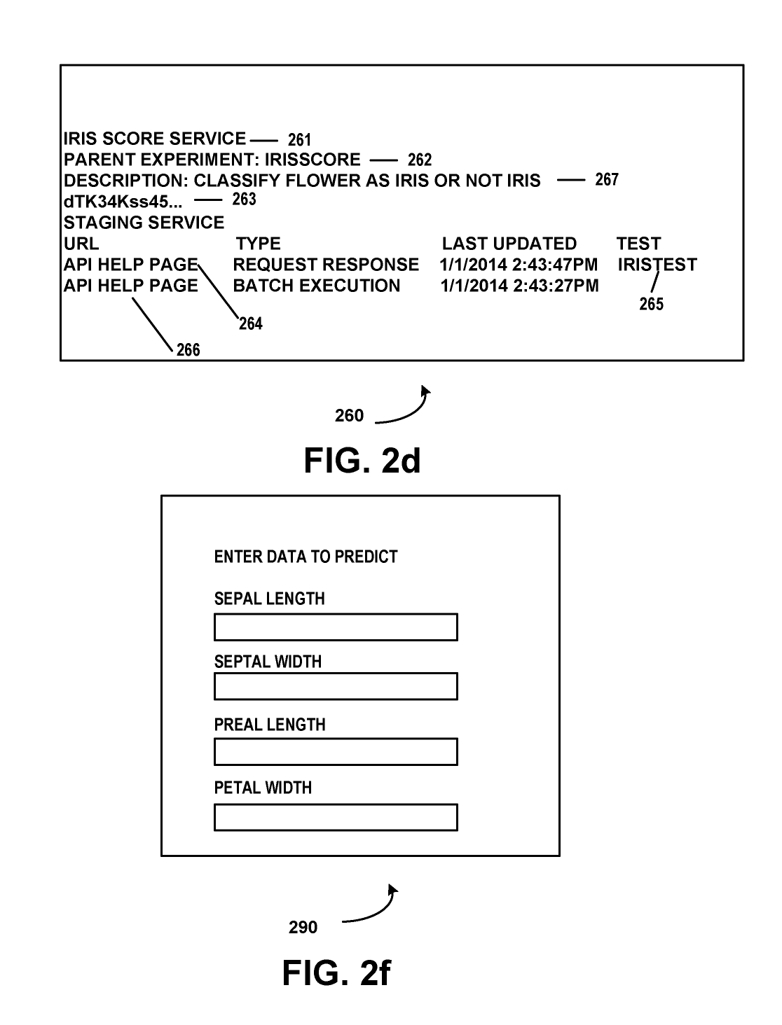

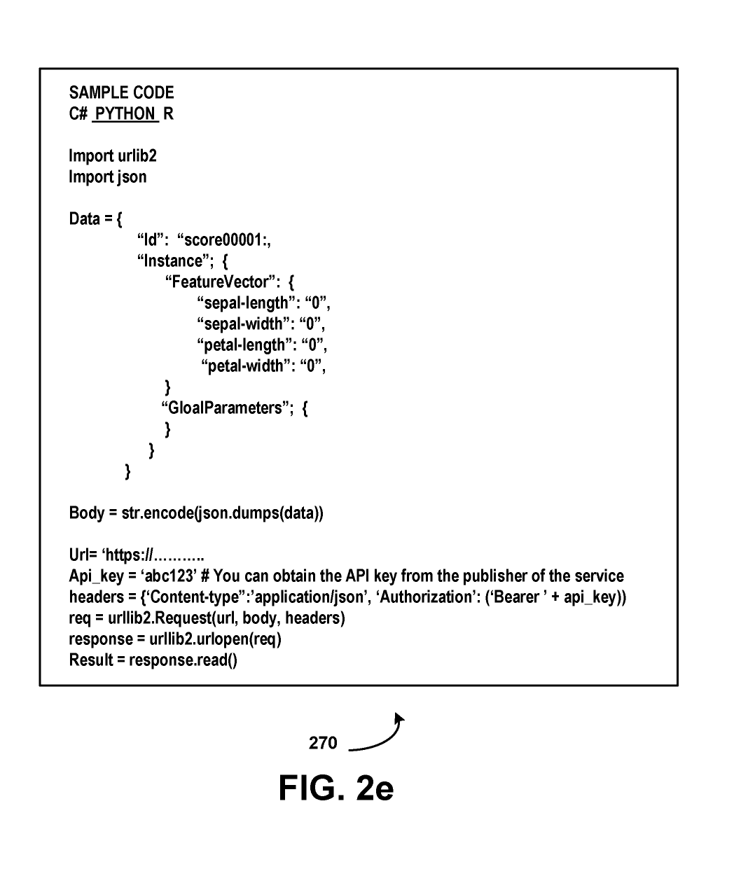

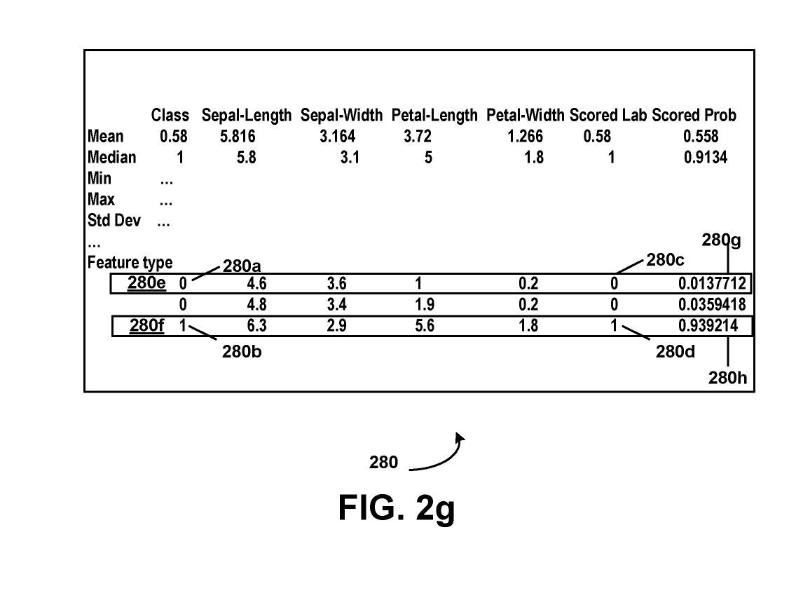

FIG. 2a illustrates an example of a method 200 for deployment of a machine learning model in accordance with aspects of the subject matter described herein. The method described in FIG. 2a can be practiced by a system such as but not limited to the ones described with respect to FIGS. 1a and 1b. While method 200 describes a series of steps or operations that are performed in a sequence, it is to be understood that method 200 is not limited by the order of the sequence depicted. For instance, some operations may occur in a different order than that described. In addition, one operation may occur concurrently with another operation. In some instances, not all operations described are performed.

At operation 201 a user-provided model can be received. At operation 202 a scoring experiment can be created. At operation 204 the scoring experiment can be executed. Testing can be performed at operation 208. Optionally an updated model can be loaded (not shown). At operation 210 auto-generation of software can be performed. At operation 212 the software can be placed in a hosting environment. FIG. 2b illustrates an example of a user interface 230 that can be used to create a scoring experiment. In accordance with some aspects of the subject matter described herein, a list of types of experiment items such as experiment items 230a can be displayed. A list of types of experiment items can include one or any combination of items such as but not limited to: test data (e.g., test data 232), trained models (e.g., models 233), data input and output (e.g., data input/output 234), data transformations (e.g., data transform 235). Any one or any combination of the items in the experiment items lists can be expanded to display the items of that category. For example, expanding test data can result in the display of test data sets, (e.g., displaying test data 1 232a), expanding trained models can result in the display of trained models (e.g., model 1 233a and model 2 233b) and so on.

The trained machine learning model, input data and any data transformations that are to be performed can be entered into the corresponding flow nodes. For example, a trained model such as model 1 233a can be selected for use in the scoring experiment by, for example, clicking and dragging model 1 233a from the experiment list 230a into the model flow node MODEL FN 236. Test data such as test data 232a can be selected for use in the scoring experiment by, for example, clicking and dragging test data 232a into test data flow node DATA FN 238. Data provided to the experiment can be labeled or unlabeled data. Labeled data is data for which the outcome is known or for which an outcome has been assigned. Unlabeled data is data for which the outcome is unknown or for which no outcome has been assigned. Data provided to the experiment can be test or production data. Data transformation instructions can be any data transformation instructions including but not limited to, for example, “ignore column 1”. Data transformation instruction can include mathematical manipulations of the data. Data transformations to be performed can be indicated by, for example, clicking and dragging saved transformations from the experiment list 230a or entering the desired data transformations in data transformations flow node DATA TRANS FN 240.

The inputs and outputs to the score model module SCORE MODEL 242 can be indicated by drawing flow connectors such as flow connectors such as flow connector 244a, flow connector 244b and flow connector 244c. For example, flow connector 244a indicates that the contents of data flow node DATA FN 238 (e.g., test data 232a) is input to the contents of data flow node DATA TRANS FN 240 (e.g., “ignore column 1”) and the transformed data and the contents of data flow node MODEL FN 236 (e.g., model 1 233a) are input to the score model module SCORE MODEL 242. The output from the score model module SCORE MODEL 242 can also be designated. The status of the experiment (e.g., Draft or Finished) can be displayed as the Status Code (e.g., STATUS CODE 244).

Selecting the RUN option, option 246 can trigger the miming of the experiment, invoking the experiment execution module 124 of FIG. 1a. FIG. 2c illustrates an example user interface 231 of a possible experiment. In the experiment displayed in FIG. 2c, execution of an experiment in which a trained model IRISSVM2 236a and transformed data (IRIS 2 CLASS DATA 238a to which a data transformation function PROJECT COLUMNS 240a has been applied) are provided to a model scoring module (SCORE MODEL 242a) to generate results 250.

FIG. 2g illustrates an example of results 280 that may be produced. Results 280 in accordance with aspects of the subject matter described herein represent labeled (classified) training data and the results computed by the experiment. It will be appreciated that unlabeled (unclassified) training data and their computed outcomes can be displayed. Similarly, production data and their computed outcomes can be displayed. For example, in row 1 280e Class 0 280a represent characteristics or features (petal-length, petal-width, sepal-length and sepal-width) for a flower that is known not to be an iris (Class 0) while row 3 280f Class 1 280b represents characteristics (petal-length, petal-width, sepal-length and sepal-width) for a flower that is known to be an iris (Class 1). The results of running the experiment indicates that the trained machine learning model has predicted that the flower of row 1 280e is not an iris (indicated by scored label 280c being Class 0 280c (not an iris) having a computed (low) probability of 0.0137712 (280g) of being an iris. The flower of row 3 280f has been predicted to be an iris (Class 1) 280d with a computed (high) probability 280h of 0.939214 of being an iris.

After the experiment has been run, the experiment can be saved (e.g., as IrisScore, for example) and an option to publish the experiment as a service can be displayed, as illustrated by PUBLISH WEB SERVICE 248 of FIG. 2c. Selection of this option can create the test web service endpoint, that is, the entry point in the auto-generated software that enables execution of the trained machine learning model software. If corrections are desired, an updated user-provided machine learning model can be loaded, changes can be made to data transformations and so on. In response to selection of this option to publish the web service, the code generation module 126 of FIG. 1a can be invoked. In accordance with some aspects of the subject matter described herein, a display such as for example, the display illustrated in screenshot 260 of FIG. 2d can be displayed. In screenshot 260, information about the service can be displayed, including the name of the service (e.g., IRIS SCORE SERVICE 261), the name of the parent experiment, (e.g., IRISSCORE 262), a description of the service (e.g., CLASSIFY A FLOWER AS IRIS OR NOT IRIS 267), an API key (e.g., dTK34Kss45 . . . 263) needed to access the service, a link (e.g., API HELP PAGE 264) to take the user to a display of automatically generated code to invoke the service as shown in FIG. 2e display 270, a link (e.g., IRIS TEST 265) to take the user to an automatically generated user interface for inputting parameters for a single request as shown in FIG. 2f, user interface 290. A user interface (not shown) that enables batch processing of multiple requests can be provided (e.g., by selecting a link such as API HELP PAGE 266). A user interface (not shown) may provide a user the opportunity to approve the trained machine learning model software for production, triggering automatic placement of the software in the production environment and enabling the software to be accessed by its users.

In response to indicating that the service is ready for placement in a hosting environment, the software can be placed in the hosting environment by placement module 128.

Disclosed is a system that includes one or more processors, a memory connected to the one or more processors and a machine learning model deployment tool. The machine learning model deployment can include one or any combination of the following: program module(s) that comprise user-interfaces. The modules can be loaded into the memory. The modules can creating software implementing a machine learning scoring experiment in response to receiving a user-provided trained machine learning model. The model can be a model developed particularly for the problem space in contrast to generic models that apply to classes of problems. The machine learning scoring experiment can be an encapsulated unit of software implementing the trained machine learning model. It can include a scoring module. It can include a program module loaded into the memory that generates software for invoking the experiment. It can include a module that places the experiment in a hosting environment. The machine learning scoring experiment can include data transformations to be applied to data received for input to the experiment. The machine learning scoring experiment can be deployed as an application. The machine learning scoring experiment can be deployed as a service. The machine learning scoring experiment can be deployed to the cloud. The system can include one or more program modules that generating a user interface for inputting data for a request for a single outcome. The system can include one or more program modules that generating a user interface for inputting data for a request for a batch of outcomes.

### The System can Include One or More Program Modules

Disclosed are one or more methods for auto-generation of software implementing a trained machine learning model. The method can include: receiving a trained machine learning model by a processor of a computing device. The process can be driven by input received from a series of user interfaces driving the generation of the software, that is, automatically generating a software unit comprising a machine learning experiment implementing the trained machine learning model and placing the software unit in a hosting environment. Data transformations to be applied to the data to be acted upon by the model software. The data transformations can be incorporated into the machine learning experiment. The machine learning experiment can be deployed to a hosting environment comprising an application, a web service, or to the cloud. A user interface for inputting data for a request for a single outcome can be auto-generated.

A computer-readable storage medium having computer-readable instructions on is described. When executed the instructions can cause one or more processors of a computing device to do any one or more or any combination of: automatically generate a software unit comprising a machine learning experiment comprising a trained machine learning model, test the machine learning experiment, place the machine learning experiment in a hosting environment, deploy the machine learning experiment to a hosting environment comprising an application, deploy the machine learning experiment to a hosting environment comprising a web service, deploy the machine learning experiment to a hosting environment comprising the cloud, provide automatically generated code for invoking the machine learning experiment, provide an automatically generated user interface for invoking the machine learning experiment for a request for a single outcome, provide an automatically generated user interface for invoking the machine learning experiment for a request for a batch of outcomes.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include media such as, but not limited to, communications signals, modulated carrier waves or any other intangible media which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable storage medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor:
a memory connected to the at least one processor; and
a machine learning model deployment tool comprising:
at least one user-interface driven program module loaded into the memory, the at least one program module creating a machine learning scoring experiment in response to receiving a user-provided trained machine learning model, the machine learning scoring experiment comprising an encapsulated unit of software implementing the trained machine learning model and a scoring module;
at least one program module loaded into the memory that generates software for invoking the experiment; and
at least one program module loaded into the memory that places the experiment in a hosting environment.

2. The system of claim 1, wherein the machine learning scoring experiment comprises data transformations.

3. The system of claim 1, wherein the machine learning scoring experiment is deployed as an application.

4. The system of claim 1, wherein the machine learning scoring experiment is deployed as a service.

5. The system of claim 1, wherein the machine learning scoring experiment is deployed to the cloud.

6. The system of claim 1, further comprising at least one module loaded into the memory the at least one module generating a user interface for inputting data for a request for a single outcome.

7. The system of claim 1, further comprising at least one module loaded into the memory the at least one module generating a user interface for inputting data for a request for a batch of outcomes.

8. A method comprising:
receiving by a processor of a computing device, a trained machine learning model;
driven by input received from a series of user interfaces driving generation, automatically generating a software unit comprising a machine learning experiment implementing the trained machine learning model; and
placing the software unit in a hosting environment.

9. The method of claim 8, further comprising:
receiving data transformations for data input to the software unit; and
incorporating the data transformations into the machine learning experiment.

10. The method of claim 8, further comprising:
deploying the machine learning experiment to a hosting environment comprising an application.

11. The method of claim 8, further comprising:
deploying the machine learning experiment to a hosting environment comprising a web service.

12. The method of claim 8, further comprising:
deploying the machine learning experiment to a hosting environment comprising a web service in the cloud.

13. The method of claim 8, further comprising:
generating a user interface for inputting data for a request for a single outcome.

14. A computer-readable storage medium comprising computer-readable instructions which when executed cause at least one processor of a computing device to:
automatically generate a software unit comprising a machine learning experiment comprising a trained machine learning model;
test the machine learning experiment; and
place the machine learning experiment in a hosting environment.

15. The computer-readable storage medium of claim 14, comprising further computer-readable instructions which when executed cause the at least one processor to:
deploy the machine learning experiment to a hosting environment comprising an application.

16. The computer-readable storage medium of claim 14, comprising further computer-readable instructions which when executed cause the at least one processor to:
deploy the machine learning experiment to a hosting environment comprising a web service.

17. The computer-readable storage medium of claim 14, comprising further computer-readable instructions which when executed cause the at least one processor to:
deploy the machine learning experiment to a hosting environment comprising the cloud.

18. The computer-readable storage medium of claim 14, comprising further computer-readable instructions which when executed cause the at least one processor to:
provide automatically generated code for invoking the machine learning experiment.

19. The computer-readable storage medium of claim 14, comprising further computer-readable instructions which when executed cause the at least one processor to:
provide an automatically generated user interface for invoking the machine learning experiment for a request for a single outcome.

20. The computer-readable storage medium of claim 14, comprising further computer-readable instructions which when executed cause the at least one processor to:
provide an automatically generated user interface for invoking the machine learning experiment for a request for a batch of outcomes.
